(19) United States
(12) Patent Application Publication
(10) Pub. No.: US 2025/0211159 A1
(43) Pub. Date: Jun. 26, 2025

(54) ROTATING MACHINE CONTROL DEVICE

(71) Applicant: Mitsubishi Electric Corporation, Tokyo (JP)

(72) Inventors: Shota KONDO, Tokyo (JP); Masahiro IEZAWA, Tokyo (JP)

(73) Assignee: Mitsubishi Electric Corporation, Tokyo (JP)

(21) Appl. No.: 18/846,286

(22) PCT Filed: Apr. 26, 2022
(86) PCT No.: PCT/JP2022/018826

§ 371 Date: Sep. 12, 2024

(51) Int. Cl. H02P 29/50; H02P 27/08

(52) U.S. Cl. CPC H02P 29/50; H02P 27/085

(57) ABSTRACT

A rotating machine control device comprises a switching instruction generation unit for exchanging a DC voltage for AC voltages by means of an electric power converter to apply them to a rotating machine, and also for instructing the switching operations of PWM pulses in the electric power converter. The switching instruction generation unit comprises an instruction voltage generator for producing an instruction voltage, and an instruction voltage compensator for compensating the aforementioned instruction voltage by means of the instruction voltage generator; and the instruction voltage compensator compensates the aforementioned instruction voltage on the basis of electric current related information of the rotating machine so that the electric current related information does not exceed a threshold value being set in advance.

### TECHNICAL FIELD

The disclosure of the present application relates to a rotating machine control device.

### BACKGROUND ART

In a control apparatus or device of a rotating machine, it is generally taking place to use a pulse width modulation technology (PWM: Pulse Width Modulation) in which switching operations of an electric power converter are utilized in order to apply a desired alternating current (AC) voltage(s) to the rotating machine. Because losses are caused in the switching operations described above in association with the switching events, it is desired that the number of switching events is decreased as much as possible. However, when the number of switching events is made decreased, there arise a problem in that the increase of voltage harmonics and that of electric current harmonics are caused, and a problem in that the peak of phase electric-current (which is also referred to as a “peak electric-current,” hereinafter) results in being increased. When peak electric-currents increase, it is feared that demagnetization or device's breakdown may be caused, and so, it is desirable to ensure the decrease of the number of switching events and the reduction of the peak electric-currents both maintaining compatibility with each other.

As a configuration in which the increase of peak electric-currents is curbed, there is a configuration in which superposition of the sixth components (fifth and seventh components on the fixed coordinates) is performed on electric current instructions, and the electric-currents are controlled so that those phase electric-current's waveforms take on trapezoidal shapes (for example, refer to Patent Document 1).

### RELATED ART DOCUMENTS

### Patent Document

[Patent Document 1] Japanese Patent Publication No. 6455295.

### Non-Patent Document

[Non-Patent Document 1] Sugimoto, et al., “Actualities of Theory and Design of AC Servo Systems (Sixth Edition),” Sogo Denshi Shuppan-Sha, August 2002, pp. 72-98.

### SUMMARY OF THE INVENTION

### Problems to be Solved by the Invention

However, in a case in which the number of switching events is decreased by the configuration of Patent Document 1, it is not possible to suitably control harmonic currents (the sixth components), so that there exists a case in which peak electric-currents result in being increased on the contrary depending on harmonic currents and their phases. In addition, in the configuration of Patent Document 1, a PWM pulse (the pulse which has undergone pulse width modulation) cannot be instantaneously manipulated, even when a peak electric-current(s) is about to exceed a predetermined value, if worse comes to worst; and thus, there arises a problem in that the peak electric-current(s) cannot be dealt with when it instantaneously increases.

For example, in a case of an FA (Factory Automation) in which the rotating machine control device is used, or in a case of an application(s) such as air-conditioning, a machine tool, an aircraft, a railway or railroad, an automotive vehicle and/or the like, a peak electric-current(s) instantaneously increases, whereby the increase gives rise to demagnetization of an electric power converter or the like, and/or its device's breakdown.

The present disclosure in the application concerned has been directed at disclosing technologies for solving those problems as described above, an object of the disclosure is to reliably curb the increase of a peak electric-current(s) flowing through a rotating machine, and to protect the rotating machine and an electric power converter therefor, when the number of switching events of the electric power converter is decreased, and/or even when a harmonic current(s) cannot be controlled at a desired value(s).

### Means for Solving the Problems

In a rotating machine's control apparatus or device disclosed in the disclosure of the application concerned which is a rotating machine control device including an electric power converter for converting a DC voltage into an AC voltage(s) and for applying the AC voltage(s) to a rotating machine, and including an electric current detector for detecting an electric current(s) to energize thereby the rotating machine therethrough, the rotating machine control device for controlling the rotating machine comprises:

a switching instruction generation unit for producing an instruction voltage on the basis of an operational instruction(s) being inputted from an outside of the switching instruction generation unit, and for giving a switching instruction(s) thereoutside, in accordance with the instruction voltage therefor, to the electric power converter, wherein

the switching instruction generation unit comprises an instruction voltage generator for producing the instruction voltage, and an instruction voltage compensator for compensating the instruction voltage produced by the instruction voltage generator; and

the instruction voltage compensator compensates the instruction voltage so that electric current related information including a value(s) of a detection electric-current(s) through the electric current detector does not exceed a threshold value being set in advance.

### Effects of the Invention

According to the rotating machine control device disclosed in the disclosure of the application concerned, it becomes achievable to reliably curb the increase of a peak electric-current(s) flowing through a rotating machine, and to protect the rotating machine and an electric power converter therefor, when the number of switching events of the electric power converter is decreased, and/or even when a harmonic current(s) cannot be controlled at a desired value(s),

### BRIEF DESCRIPTION OF DRAWINGS

FIG. 1 is a schematic diagram illustrating, by way of example, a rotating machine control device according to Embodiment b 1;

FIG. 2 is a block diagram for explaining an internal configuration of a switching instruction generation unit in the rotating machine control device according to Embodiment 1;

FIG. 3 is a block diagram for explaining an internal configuration of an instruction voltage compensator in the rotating machine control device according to Embodiment 1;

FIG. 4 is a block diagram for explaining an internal configuration of a hysteresis comparator in the rotating machine control device according to Embodiment 1;

FIG. 5 is a block diagram for explaining an internal configuration of an allowable width setting unit in the rotating machine control device according to Embodiment 1;

FIG. 6 is a diagram showing an operational example in a case in which the compensation of an instruction voltage is not carried out in the rotating machine control device according to Embodiment 1;

FIG. 7 is a diagram showing an operational example in a case in which the compensation of an instruction voltage is carried out in the rotating machine control device according to Embodiment 1;

FIG. 8 is a diagram showing an operational example in a case in which the compensation of an instruction voltage is not carried out in the rotating machine control device according to Embodiment 1;

FIG. 9 is a diagram showing an operational example in a case in which the compensation of an instruction voltage is carried out in the rotating machine control device according to Embodiment 1;

FIG. 10 is a diagram showing an operational example in a case in which the compensation of an instruction voltage is carried out in the rotating machine control device according to Embodiment 1, and, what is more, values of allowable widths are changed; and

FIG. 11 is a hardware configuration diagram of the switching instruction generation unit in the rotating machine control device according to Embodiment 1.

### EMBODIMENTS FOR CARRYING OUT THE INVENTION

### Embodiment 1

Hereinafter, the explanation will be made in detail referring to the drawings for a rotating machine's control apparatus or device according to Embodiment 1 in the present disclosure in the application concerned.

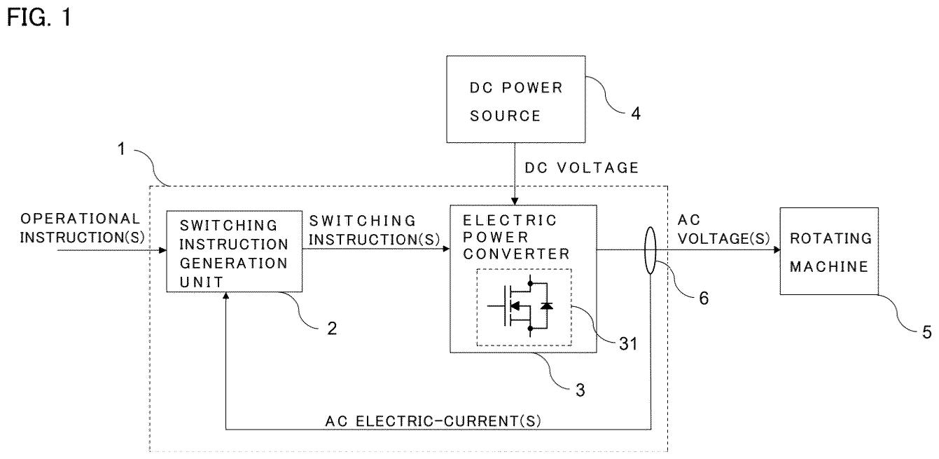

FIG. 1 is a schematic diagram of a rotating machine control device according to Embodiment 1. The rotating machine control device 1 is constituted of: a switching instruction generation unit 2; an electric power converter 3 to which a direct current (DC) voltage from a DC power source 4 is applied, and by which AC voltages being undergone through the electric power conversion are applied to a rotating machine 5; and an electric current detector 6 for detecting an alternating or AC electric-current(s) outputted from the electric power converter 3.

The switching instruction generation unit 2 produces an instruction voltage in the shape of a pulse (hereinafter, which is also referred to as a “voltage instruction”) on the basis of instruction torque or an operational instruction such as an instructed rotational speed, an electric current instruction or the like, and on that of an AC electric-current(s), so that a switching instruction(s) is given outside to the electric power converter 3. The electric power converter 3 comprises switching devices 31 constituting full-bridge circuitry, for example, and is connected to the DC power source 4 and to the rotating machine 5 through the wiring with one another. The electric power converter produces AC voltages from a DC voltage of the DC power source 4 in accordance with a switching instruction(s) given from the switching instruction generation unit 2, and applies the AC voltages to the rotating machine 5. It should be noted that, in a case in which a rotational speed approaches the value the aforementioned AC electric-current and the aforementioned AC voltage take on a direct current (DC) and a DC voltage, and that, in a case in which an offset component is contained, the aforementioned AC electric-current and the aforementioned AC voltage include not only an AC component but also a DC component, as a matter of course. The electric current detector 6 detects electric currents iu, iv and iw in each of the phases (phase-U, phase-V and phase-W) of the rotating machine 5, respectively.

Note that, as for the electric current detector 6, an electric current's instruction value(s) defined in advance may also be used as a replacement in place of part of respective phases or all of them, In addition, from rotating machine characteristics as given in Expression (1), an electric, current's estimation value estimated by means of an electric current estimator for predicting or estimating an electric current may also be used as a replacement. Moreover, a configuration in which an electric current on a DC busbar side is detected and an electric current of each phase is calculated may also be used as a replacement. There also arises a case in which the electric current estimator may be used in place of an electric current sensor(s) in order to reduce the cost; however, in a case in which the accuracy of an electric current sensor or the response thereof is low, it is possible to reliably observe an electric current which is transiently changing, when the electric current estimator is used as a replacement.

According to this arrangement, in a case in which no electric current sensor exists, and/or even in a case in which the response of an electric current sensor(s) is slow, it is possible to protect a rotating machine and/or an electric power converter with reliability.

$$[ Expression 1 ]$$

$$[ \begin{matrix}{v}_{u} \\ {v}_{v} \\ {v}_{w}\end{matrix} ] = [ \begin{matrix}R + {sL}_{u} & {sM}_{uv} & {sM}_{wu} \\ {sM}_{uv} & R + {sL}_{v} & {sM}_{vw} \\ {sM}_{wu} & {sM}_{vw} & R + {sL}_{w}\end{matrix} ] [ \begin{matrix}{i}_{u} \\ {i}_{v} \\ {i}_{w}\end{matrix} ] + {ω}_{re} {ϕ}_{mag} [ \begin{matrix}- sin {θ}_{re} \\ - sin ( {θ}_{re} - \frac{2}{3} π ) \\ - sin ( {θ}_{re} - \frac{4}{3} π )\end{matrix} ] \qquad ( 1 )$$

Here, Expression (1) gives voltage equations on the fixed coordinates (uvw coordinates) of a rotating machine. Where, symbols “Vu, Vv and Vw” indicate phase voltages each; symbol “R,” winding resistance; symbol “s,” a differential operator; symbols “Lu, Lv and Lw” each, self-inductance of each winding; symbols “Muv, Mwu and Mvw” each, mutual inductance between respective windings; symbols “iu, iv and iw,” phase electric-currents each; symbol “ωᵣₑ,” an electrical angular velocity; symbol “ϕ_{mag},” permanent magnet's magnetic flux; and symbol “θᵣₑ,” an electrical angular position, respectively.

Note that, as for the rotating machine 5, a three-phase synchronous motor or a three-phase induction motor is put under presumption; however, for example, the rotating machine may be made of a double-or dual-winding three-phase motor or a motor other than the three-phase one such as a five-phase motor, or a field-winding-type motor, for example; or the rotating machine may be made of another synchronous motor such as a synchronous reluctance-type motor or a switched reluctance-type motor, or may also be made of other than the induction motor.

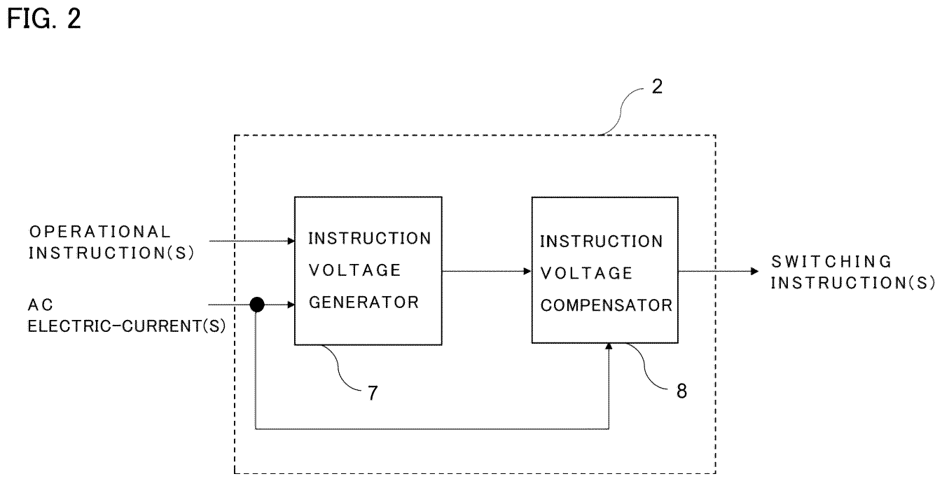

Next, the explanation will be made for FIG. 2. FIG. 2 is a block diagram for explaining an internal configuration of the switching instruction generation unit 2 according to Embodiment 1. The switching instruction generation unit 2 is constituted of an instruction voltage generator 7 and an instruction voltage compensator 8,

The instruction voltage generator 7 produces an AC voltage instruction(s), on the basis of an operational instruction(s) and on that of an AC electric-current(s), by means of a publicly known scheme (refer to Non-Patent Document 1). A configuration may appropriately be used in which the AC voltage instruction(s) is implemented by such a way that the operational instruction(s) is converted into an electric current instruction(s), and an electric current vector is controlled on rotational coordinates (on the d-q coordinates) so that the aforementioned AC electric-current(s) follows up the aforementioned electric current instruction(s); or another configuration may also be used by such a way under a V/f-ratio constant control in which a three-phase voltage instruction(s) is acquired in accordance with an instructed rotational speed.

In addition, though not shown in the figure, rotor's position information is acquired at a time when the electric current vector control is carried out by means of a position sensor such as a resolver and/or an encoder, and/or by means of a position estimator which acts as a replacement for the position sensor, so that an AC voltage instruction(s) is produced.

After the AC voltage instruction(s) has been produced, PWM pulses are generated or produced in order to instruct the switching operations of the electric power converter 3. The PWM pulses are produced so that, at least, fundamental wave components of the PWM pulses and fundamental wave components of AC voltage instructions are coincident with each other; and, in general, the PWM pulses are calculated by comparing a triangular wave carrier with the AC voltage instructions.

The triangular wave carrier is made of a synchronous carrier (synchronous PWM) which is synchronous to a voltage phase or to a rotational speed, or is made of an asynchronous carrier (asynchronous PWM) which is not synchronous to the voltage phase or to the rotational speed. As other schemes, not only by means of the comparison with the triangular wave carrier, the PWM pulses may also be calculated by means of a direct torque control and/or by means of an optimal pulse pattern scheme, a low-order harmonic elimination scheme, a spatial vector modulation scheme, a hysteresis comparator scheme, and the like,

However, even though the PWM pulses are calculated by any one of the schemes described above, such tendency can be observed that voltage harmonics and electric current harmonics are decreased whenever the number of PWM pulses per one in-between period in electrical angle is large, and that the voltage harmonics and the electric current harmonics are increased whenever the number of those PWM pulses is small. When the voltage harmonics and the electric current harmonics are increased, a peak electric-current(s) results in being increased. If a peak electric-current(s) becomes larger than an electric current's upper-limit value, there exists a possibility in such a case that demagnetization and/or device's breakdown are caused, and thus, the control should be carried out so that the peak electric-current(s) flowing through a rotating machine does not exceed the electric current's upper-limit value at any time when possible.

Meanwhile, when consideration is given to a viewpoint of a switching loss, switching losses are increased whenever the number of PWM pulses per one in-between period in electrical angle is large; whereas, the switching losses are decreased whenever the number of those PWM pulses is small. And then, in a case in which the switching losses increase, the generation of heat and the reduction of efficiency are caused.

According to the manner described above, voltage harmonics and electric current harmonics, and switching losses demonstrate the relationship of trade-off therebetween, and thus, in general, it is desired that the number of switching events is decreased so that a peak electric-current does not exceed an electric-current's upper limit.

The instruction voltage compensator 8 corrects or compensates a PWM pulse(s) in accordance with a PWM pulse(s) produced by means of the instruction voltage generator 7, and in accordance with a detection electric-current(s) detected by means of the electric current detector 6; and the instruction voltage compensator produces a switching instruction(s) being inputted into the electric power converter 3.

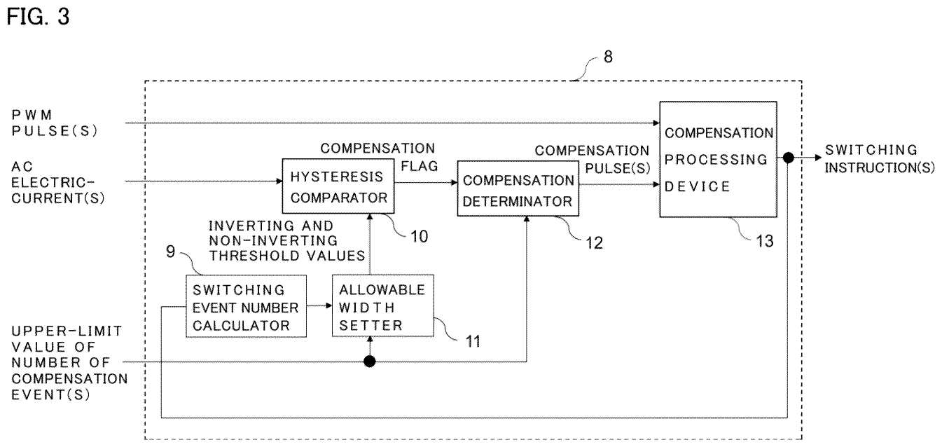

FIG. 3 is a block diagram for explaining an internal configuration of the instruction voltage compensator 8 according to the rotating machine control device of Embodiment 1. The instruction voltage compensator 8 is constituted of a switching event number calculator 9, a hysteresis comparator 10, a permissible or allowable width setter 11, a correction or compensation determinator 12 and a correction or compensation processing device 13.

The switching event number calculator 9 calculates the number of switching event(s) on the basis of a switching instruction(s) having been produced by the compensation processing device 13, and outputs the number of switching event(s) into the allowable width setter 11.

The hysteresis comparator 10 performs determination whether or not a PWM pulse(s) produced by the instruction voltage generator 7 should be compensated on the basis of a value(s) of a detection electric-current(s) having been detected by means of the electric current detector 6 and on that of inverting and non-inverting threshold values outputted from the allowable width setter 11, and outputs a correction or compensation flag.

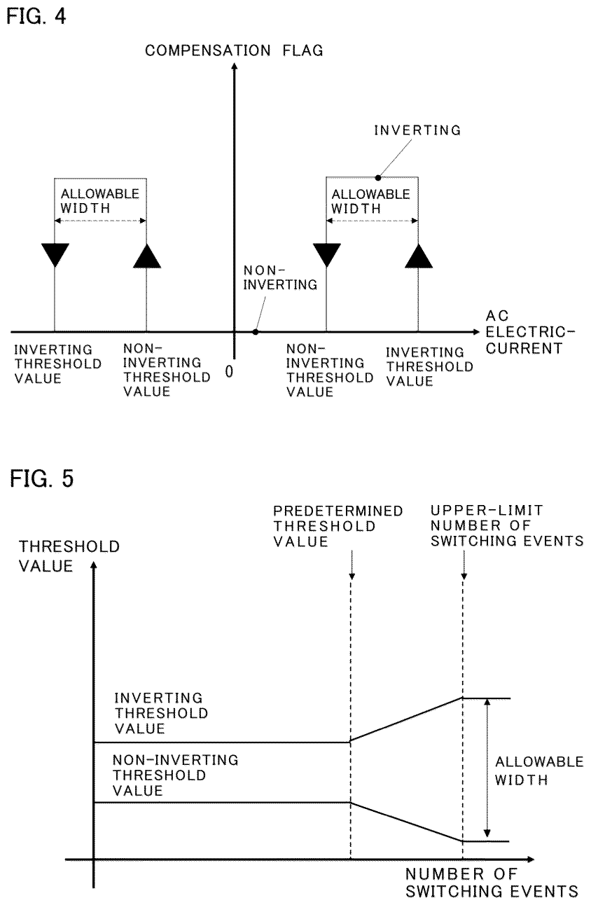

To be specific, an inverting threshold value and a non-inverting threshold value are set with respect to a positive side of an AC electric-current and a negative side thereof as shown in FIG. 4; when the amplitude of the AC electric-current takes on a larger value than an inverting threshold value (also referred to as a “first threshold value”), a compensation flag is outputted so that a PWM pulse (positive or negative polarity thereof) produced by the instruction voltage generator 7 is inverted (hereinafter, inverting processing). The operations of inverting the PWM pulse(s) is continued in accordance with the compensation flag, and, when the amplitude of the AC electric-current takes on a smaller value than a non-inverting threshold value (also referred to as a “second threshold value”), the PWM pulse(s) is not inverted (non-inverting); namely, the compensation flag is outputted so that the PWM pulse(s) produced by the instruction voltage generator 7 is outputted as it is (hereinafter, non-inverting processing).

These mean that the characteristics are utilized in which a phase electric-current changes in the direction of the polarity of PWM pulse (when a PWM pulse is at a high (Hi), a phase electric-current becomes larger in a positive direction; whereas, when the PWM pulse is at a low (Low), the phase electric-current becomes larger in a negative direction), which means that, in a case in which a peak electric-current is predicted and/or estimated so that the peak electric-current is to exceed an electric current's upper-limit value, a PWM pulse(s) is inverted, so that the peak electric-current is reduced.

According to the configuration, it is possible to instantaneously manipulate a PWM pulse(s) even when a peak electric-current is about to exceed a predetermined value; and thus, the control can be carried out so that the peak electric-current does not exceed an electric current's upper-limit value with reliability. In addition, the PWM pulse(s) is compensated in the configuration as described above, whereby it is possible to curb the increase of only a peak electric-current which is transiently changing, without hardly exerting an influence on a fundamental wave component of an instruction voltage produced by the instruction voltage generator 7 (it is not necessary to change the instruction so as to reduce the output).

Here, a case is cited in which, by way of example, the peak of detection electric-current exceeds a threshold value; however, the case may also be cited in which, other than the peak of detection electric-current, an item being targeted belongs to a voltage and/or an electric current including their harmonics, a loss, electric power, torque, the number of revolutions, a position of the rotor, a temperature or the like (for example, the amplitude of a specific harmonic voltage, that of an electric current and/or the like; and the sum of those amplitudes or the like).

As explained above, the rotating machine control device of Embodiment 1 is capable of controlling a switching instruction(s) so as to compensate it so that the peak of electric-current flowing through a rotating machine does not exceed a predetermined threshold value, and thus, the rotating machine and/or an electric power converter can be protected with reliability.

The allowable width setter 11 performs determination on inverting and non-inverting threshold values on the basis of the number of switching event(s) of the switching event number calculator 9 and on that of an upper-limit value of the number of compensation event(s) being a count number of compensating a switching instruction(s), and outputs the inverting and non-inverting threshold values into the hysteresis comparator 10. Here, as for a permissible or allowable width, it designates the difference between a non-inverting threshold value and an inverting threshold value. The inverting threshold value is set at a value so that a peak electric-current does not reliably exceed an electric-current's upper-limit value during a time-period from electric-current detection until a voltage output. The non-inverting threshold value is set at a value so that a PWM pulse compensated during inverting processing is not separated from a PWM pulse produced by means of the instruction voltage generator 7 to a large extent, and also is set at the value so that the number of switching event(s) does not become excessively large because the number of inverting processing events excessively increases.

To be specific, when the difference between an inverting threshold value and a non-inverting threshold value (an allowable width therebetween) is made excessively large, a voltage instruction in being produced which is separated from a PWM pulse produced by the instruction voltage generator 7 to a large extent, so that the control is not stabilized. On the other hand, when the allowable width is made excessively small, “inverting” and “non-inverting” result in being repeated more than required, and so, switching losses result in being increased more than necessary.

For dealing therewith, as shown in FIG. 5, an inverting threshold value and a non-inverting threshold value are set in advance so that a peak electric-current does not exceed an electric current's upper-limit value with reliability, and also that their values are not separated from a PWM pulse produced by the instruction voltage generator 7 to a large extent. Only in a case in which the number of switching event(s) becomes large more than required, the inverting threshold value and the non-inverting threshold value are changed, and thus, they are set so that an allowable width therebetween becomes larger. When the allowable width is made larger, inverting and/or non-inverting threshold values exert difficulty in reaching at them, and thus, it is possible to decrease the number of compensation event(s).

Here, as for the inverting threshold value and the non-inverting threshold value, it is named that, by way of example, they are changed in accordance with the number of switching event(s); however, it is also possible to change their values not only in accordance with the number of such switching event(s), but also in accordance with any one or more of situations among the number of revolutions, an electric current, a voltage, torque, a position of the rotor, a temperature of a rotating machine, and a temperature of an electric power converter. According to this arrangement, even in any one of situations (in a case in which the influence due to heat is especially large), it becomes possible to reliably and suitably protect the rotating machine and the electric power converter.

By manipulating the allowable width, the operations thereby can also be performed as follows. When an allowable width is set whether on purpose or not to become larger than that which is necessary, it becomes possible to increase a modulation-factor instruction of an AC voltage instruction produced by the instruction voltage generator 7. Under this situation, if the amplitude of AC voltage instruction can be made larger than that of a triangular wave carrier at the time when a PWM pulse(s) is produced, it is possible to implement an overmodulation drive, so that the number of such switching events can be decreased.

An overmodulation drive is a technology generally used in a case in which a utilization factor of an output of an electric power converter is made larger; however, in a case of the current configuration, the overmodulation drive can be utilized in the decrease of the number of switching event(s). It should be understood that, even when the overmodulation drive is carried out, a phase electric-current in vicinity to the peak thereof is controlled by means of the hysteresis comparator 10 so that the phase electric-current does not reach at an electric-current's upper limit, and thus, the overmodulation drive can be implemented while the advantage is maintained in which a peak electric-current(s) does not increase more than necessary.

The compensation determinator 12 performs determination on the presence or absence of compensation on a PWM pulse(s) on the basis of a compensation flag of the hysteresis comparator 10 and on that of an upper-limit value of the number of compensation event(s), and outputs a compensation pulse(s). The upper-limit value of the number of compensation event(s) is an upper-limit value in which an upper limit of the number of the compensation event(s) during one in-between period of control's time-period is defined, so that the upper-limit value acts on preventing the increase of the number of switching event(s) to a large extent. In a case in which the number of compensation event(s) during one in-between period of control's time-period in accordance with a compensation flag does not reach at an upper-limit value of the number of such compensation event(s), a compensation pulse(s) is outputted so that the compensation is made allowed; whereas, in a case in which the number of compensation event(s) in accordance with a compensation flag exceeds an upper limit, there exists a possibility that a peak electric-current exceeds an electric-current's upper limit, or that the number of switching events is increased excessively large, and thus, a change is caused so that the operations are made halted, or that an allowable width(s) of the allowable width setter 11 is set to an appropriate value. As described above, according to the rotating machine control device of Embodiment 1, it is possible to achieve detection of an abnormal state.

The compensation processing device 13 produces a switching instruction(s) by using a PWM pulse(s) produced by means of the instruction voltage generator 7 and using a compensation pulse(s) produced by means of the compensation determinator 12, and outputs the switching instruction(s) into the electric power converter 3.

As explained above, by providing the hysteresis characteristics with the presence or absence of compensation of a switching instruction, it is made possible to prevent an occasion in which the number of switching compensation event(s) is increased excessively large.

Next, the explanation will be made for operation- or working-effects by means of the rotating machine control device 1.

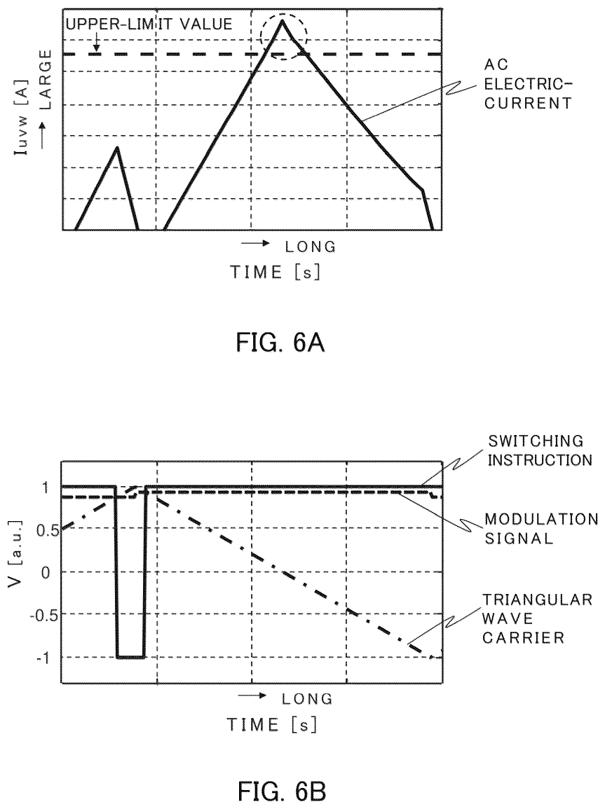

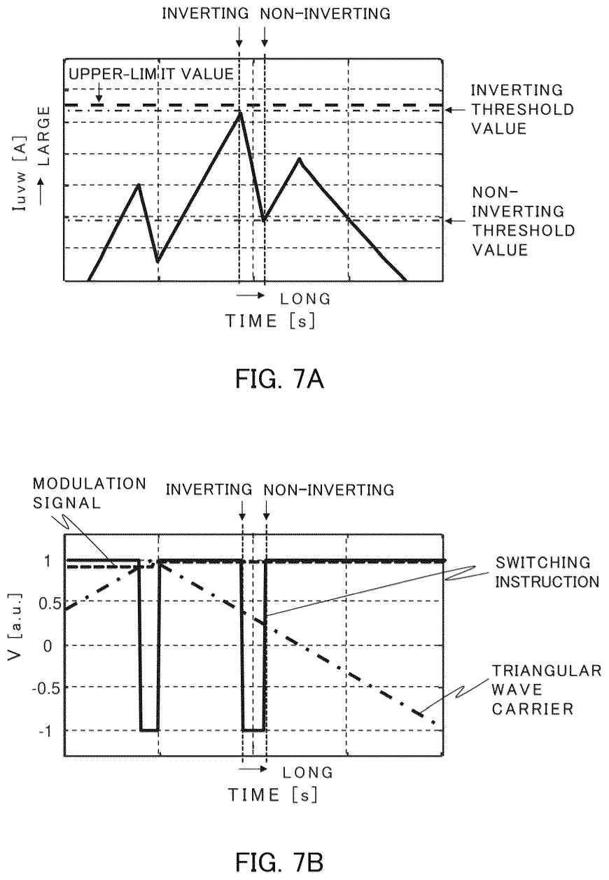

FIG. 6A and FIG. 6B are diagrams each showing a result in which an AC electric-current waveform is enlarged in a case in which such an instruction voltage compensator 8 was not provided according to conventional PWM pulses. FIG. 6A indicates electric current characteristics, and FIG. 6B indicates voltage characteristics (which are also applicable in FIG. 7A through FIG. 10A, and in FIG. 7B through FIG. 10B in similar fashions as will be explained below, respectively). In addition, in FIG. 6B, the characteristics of a switching instruction are indicated by the solid line; the characteristics of a modulation signal, by the broken lines; and the characteristics of a triangular wave carrier, by the alternate long and short dashed lines, respectively (which are also applicable in FIG. 7B through FIG. 10B in a similar fashion as will be explained below).

As specifically shown in FIG. 6B, when the number of switching event(s) is small, a peak electric-current of the AC electric-current waveform results in exceeding an upper-limit value of the electric-current (refer to the circular portion surrounded by the broken lines within FIG. 6A).

FIG. 7A and FIG. 7B are diagrams each showing a result in which an AC electric-current waveform is enlarged in a case in which the instruction voltage compensator 8 was provided and a PWM pulse(s) was corrected or compensated. In the case shown above, the peak of the AC electric-current does not occur to reach at an upper-limit value of the electric-current; however, because the electric-current increases heading towards the upper-limit value thereof, and because of the increase if it continues as it is, the electric-current could result in exceeding an inverting threshold value being a value smaller than the upper-limit value of the aforementioned electric-current (refer to FIG. 7A).

When the inverting threshold value is exceeded, a PWM pulse is compensated by means of the instruction voltage compensator 8, so that a switching instruction is reversed or inverted (refer to FIG. 7B); and thus, the peak electric-current does not occur to reach at the electric current's upper limit (refer to FIG. 7A). In addition, at a time when an AC electric-current becomes smaller than a non-inverting threshold value during inverting processing, the inverting processing is released, and a PWM pulse(s) produced by the instruction voltage generator 7 is outputted, and thus, stable control operations are made possible.

That is to say, a pulse waveform(s) (switching signal(s)) is directly manipulated, and thus, the peak electric-current is protected with more reliability,

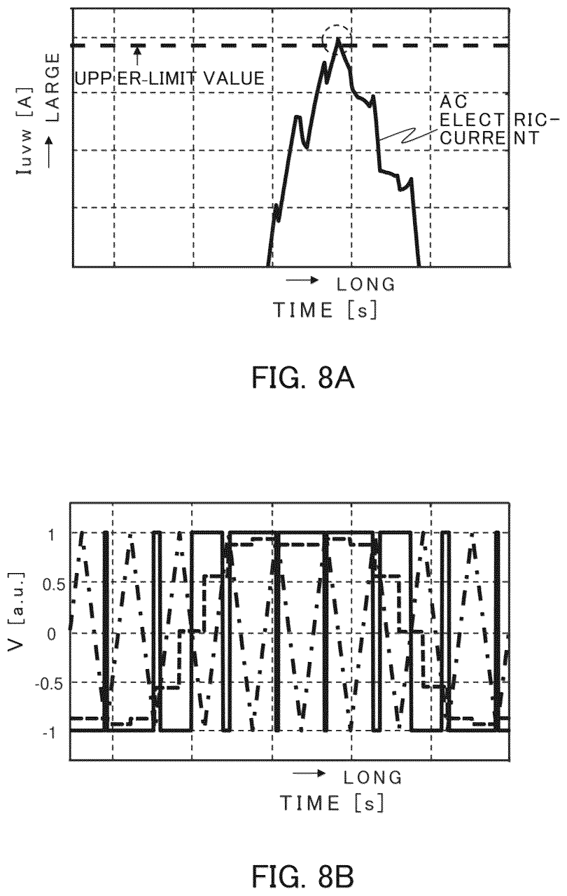

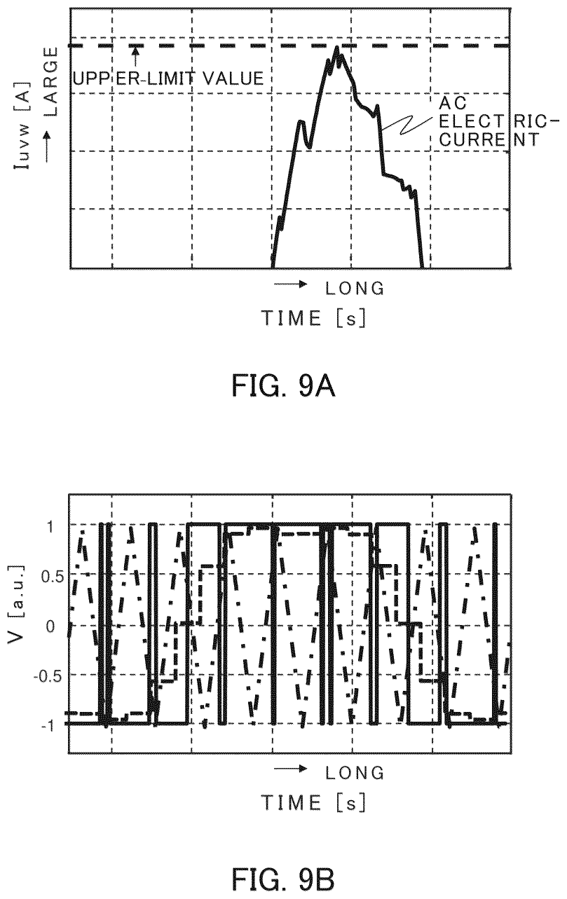

FIG. 8A and FIG. 8B each indicate the operations in a case in which the number of switching events is increased. In FIG. 8A similar to FIG. 6A and also in FIG. 8B similar to FIG. 6B, explicitly indicated is a result of an AC electric-current waveform according to conventional PWM pulses; whereas, in FIG. 9A similar to FIG. 7A and also in FIG. 9B similar to FIG. 7B, indicated is a result in which the PWM pulses were corrected or compensated by means of the instruction voltage compensator 8, and in which the control was performed so that a peak electric-current(s) did not reach at an electric current's upper limit.

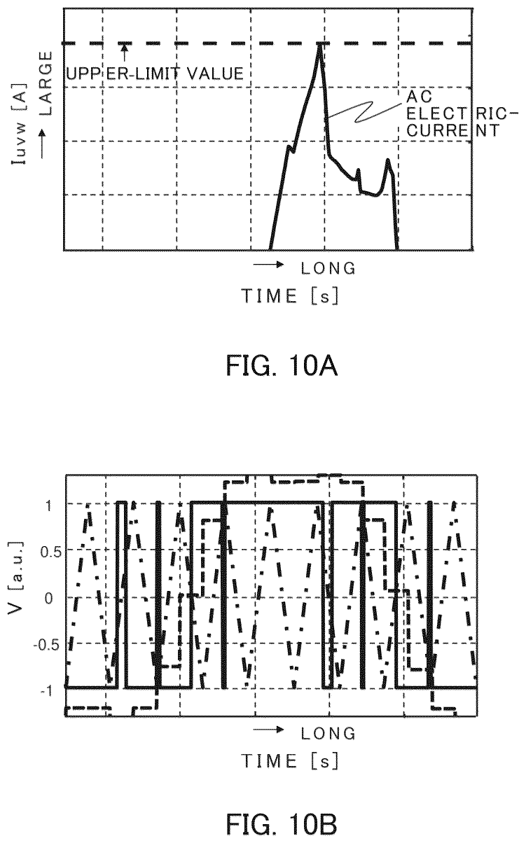

As shown in FIG. 9A, the control is performed so that the peak electric-current does not reach at the upper limit; however, as described above, it is feared that the number of switching event(s) is increased excessively large by correcting or compensating a PWM pulse(s). In such a case, by setting the permissible or allowable widths larger than those in the case shown in FIG. 9A and FIG. 9B, an overmodulation drive can be implemented, so that it becomes possible to keep on a situation in which a peak electric-current(s) does not reach at an electric current's upper limit, and also to decrease the number of switching event(s) (refer to FIG. 10A and FIG. 10B). That is to say, it is made possible to prevent the increase in the number of switching event(s) by means of the instruction voltage compensator.

In the disclosure of the application concerned, it has been described that a PWM pulse(s) is compensated so that an electric-current flowing through a rotating machine does not exceed an electric current's upper-limit value, and so, basically, the control is carried out so that electric current related information such as an electric-current, an electric current's instruction value or an electric current's estimation value does not exceed a threshold value; however, even in a case in which the electric-current results in exceeding the threshold value without intension (in such a case that a sampling error(s), a sensor error(s) and/or the like are caused), similar effects can be obtained. Hence, the scope of implementation in the disclosure of the application concerned is not limited to a case in which the electric-current or the electric current related information does not exceed a threshold value.

In addition, according to the manner described above, it has been described in such a way that a PWM pulse(s) is directly compensated so that an electric-current flowing through a rotating machine does not exceed an electric-current's upper-limit value; however, the configuration may also be adopted in such a manner that the amplitude of an instruction voltage for producing the PWM pulse(s) and/or a phase of the instruction voltage therefor are compensated, so that the PWM pulse(s) is indirectly compensated. To be specific, in a case in which an electric-current flowing through a rotating machine exceeds a first threshold value, the amplitude of an instruction voltage and/or a phase thereof are compensated so that the polarity of a PWM pulse(s) is inverted; and, in a case in which the electric-current flowing through the rotating machine becomes smaller than a second threshold value, a compensation quantity of the amplitude of the instruction voltage and/or that of a phase thereof are made smaller so that the polarity of the PWM pulse(s) is not inverted. As another configuration, at a time when a PWM pulse(s) is produced in place of the instruction voltage, the amplitude of a triangular wave carrier being used and/or a phase thereof are similarly compensated, and the PWM pulse(s) is indirectly compensated, whereby, also in such a configuration, similar effects can be obtained.

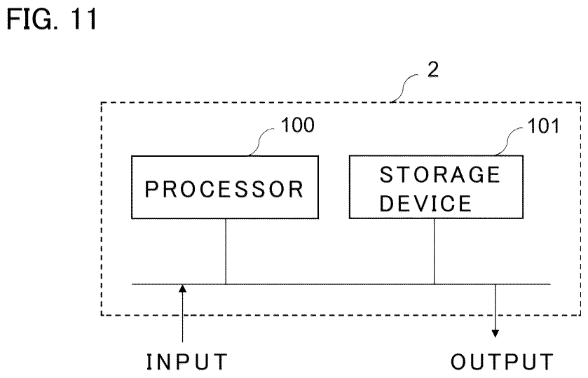

Moreover, illustrated in FIG. 11 is an example of the hardware of the switching instruction generation unit 2 in the rotating machine control device 1 in the present disclosure of the application concerned. The switching instruction generation unit is constituted of a processor 100 and a storage device 101; and the storage device 101 is provided with a volatile storage device of a random-access memory (RAM) or the like, and with a nonvolatile auxiliary storage device of a flash memory or the like, which are not shown in the figure. In addition, in place of the flash memory, an auxiliary storage device of a hard disk or the like may be provided with.

Furthermore, in the disclosure of the application concerned, exemplary embodiments are described; however, various features, aspects and functions described in an embodiment(s) are not necessarily limited to the applications of a specific embodiment(s), but are applicable in an embodiment(s) solely or in various combinations.

Therefore, limitless modification examples not being exemplified can be presumed without departing from the scope of the technologies disclosed in Description of the disclosure of the application concerned. For example, there exists a modification example which is included as a case in which at least one constituent element is modified, or added to or eliminated from a constituent element(s) of another embodiment.

### Explanation of Numerals and Symbols

Numeral “1” designates a rotating machine control device; “2,” switching instruction generation unit; “3,” electric power converter; “4,” DC power source; “5,” rotating machine; “6,” electric current detector; “7,” instruction voltage generator; “8,” instruction voltage compensator; “9,” switching event number calculator; “10,” hysteresis comparator; “11,” allowable width setter; “12,” compensation determinator; “13,” compensation processing device; “31,” switching device; “100,” processor; and “101,” storage device.

1. A rotating machine control device including an electric power converter for converting a direct-current voltage into an alternating-current voltage and for applying the alternating-current voltage to a rotating machine, and including an electric current detector for detecting an electric current to energize thereby the rotating machine therethrough, the rotating machine control device for controlling the rotating machine, comprising:
switching instruction generation circuitry for producing an instruction voltage on a basis of an operational instruction being inputted from an outside of the switching instruction generation circuitry, and for giving a switching instruction thereoutside, in accordance with the instruction voltage therefor, to the electric power converter, wherein
the switching instruction generation circuitry comprises an instruction voltage generator for producing the instruction voltage, and an instruction voltage compensator for compensating the instruction voltage produced by the instruction voltage generator; and
the instruction voltage compensator compensates the instruction voltage so that electric current related information including a value of a detection electric-current through the electric current detector does not exceed a threshold value being set in advance.

2. The rotating machine control device as set forth in claim 1, wherein the instruction voltage compensator operates so that the instruction voltage is compensated, when the electric current related information exceeds a first threshold value being set in advance; and the instruction voltage compensator operates, in accordance with the operation thereby, so that a quantity of compensation in the instruction voltage is made smaller, when the electric current related information becomes smaller than a second threshold value being set in advance.

3. The rotating machine control device as set forth in claim 1, wherein the instruction voltage compensator operates so that a polarity of a pulse-width-modulation pulse produced in accordance with the instruction voltage is inverted, when the electric current related information exceeds a first threshold value being set in advance; and the instruction voltage compensator operates, in accordance with the operation thereby, so that a polarity of a pulse-width-modulation pulse produced in accordance with the instruction voltage is not inverted and that the pulse-width-modulation pulse is outputted as it is, when the electric current related information becomes smaller than a second threshold value being set in advance.

4. The rotating machine control device as set forth in claim 2, wherein
the instruction voltage compensator includes a switching event number calculator for calculating a number of switching events; and
the instruction voltage compensator changes said first threshold value and said second threshold value so that a difference between said first threshold value and said second threshold value becomes larger, when the number of switching event is larger than a threshold value being set in advance.

5. The rotating machine control device as set forth in claim 2, wherein said first threshold value and said second threshold value are changed in values in accordance with any one or more of situations among a number of switching events, an electric current, a voltage, torque, a position of a rotor, a temperature of the rotating machine, and a temperature of the electric power converter.

6. The rotating machine control device as set forth in claim 1, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

7. The rotating machine control device as set forth in claim 1, wherein
the instruction voltage compensator includes a compensation determinator for determining a presence or absence of compensation in the instruction voltage; and
the compensation determinator calculates a number of events for compensating the instruction voltage during an in-between period being set in advance, and an output of the compensation determinator is halted when a number of events for compensating the instruction voltage exceeds an upper-limit value of a number of compensation events being set in advance.

8. The rotating machine control device as set forth in claim 2, wherein the instruction voltage compensator operates so that a polarity of a pulse-width-modulation pulse produced in accordance with the instruction voltage is inverted, when the electric current related information exceeds a first threshold value being set in advance; and the instruction voltage compensator operates, in accordance with the operation thereby, so that a polarity of a pulse-width-modulation pulse produced in accordance with the instruction voltage is not inverted and that the pulse-width-modulation pulse is outputted as it is, when the electric current related information becomes smaller than a second threshold value being set in advance.

9. The rotating machine control device as set forth in-claim 3, wherein said first threshold value and said second threshold value are changed in values in accordance with any one or more of situations among a number of switching events, an electric current, a voltage, torque, a position of a rotor, a temperature of the rotating machine, and a temperature of the electric power converter.

10. The rotating machine control device as set forth in claim 4, wherein said first threshold value and said second threshold value are changed in values in accordance with any one or more of situations among a number of switching events, an electric current, a voltage, torque, a position of a rotor, a temperature of the rotating machine, and a temperature of the electric power converter.

11. The rotating machine control device as set forth in claim 2, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

12. The rotating machine control device as set forth in claim 3, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

13. The rotating machine control device as set forth in claim 4, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

14. The rotating machine control device as set forth in claim 5, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

15. The rotating machine control device as set forth in claim 8, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

16. The rotating machine control device as set forth in claim 9, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

17. The rotating machine control device as set forth in claim 10, wherein the electric current related information includes at least an electric current of the rotating machine, a value of a detection electric-current detected by an electric current sensor, an electric current's instruction value defined in advance, and an electric current's instruction value estimated or predicted from a characteristic of the rotating machine.

18. The rotating machine control device as set forth in claim 2, wherein
the instruction voltage compensator includes a compensation determinator for determining a presence or absence of compensation in the instruction voltage; and
the compensation determinator calculates a number of events for compensating the instruction voltage during an in-between period being set in advance, and an output of the compensation determinator is halted when a number of events for compensating the instruction voltage exceeds an upper-limit value of a number of compensation events being set in advance.

19. The rotating machine control device as set forth in claim 3, wherein
the instruction voltage compensator includes a compensation determinator for determining a presence or absence of compensation in the instruction voltage; and
the compensation determinator calculates a number of
events for compensating the instruction voltage during an in-between period being set in advance, and an output of the compensation determinator is halted when a number of events for compensating the instruction voltage exceeds an upper-limit value of a number of compensation events being set in advance.

20. The rotating machine control device as set forth in claim 4, wherein
the instruction voltage compensator includes a compensation determinator for determining a presence or absence of compensation in the instruction voltage; and
the compensation determinator calculates a number of
events for compensating the instruction voltage during an in-between period being set in advance, and an output of the compensation determinator is halted when a number of events for compensating the instruction voltage exceeds an upper-limit value of a number of compensation events being set in advance.
